(19) United States
(12) Patent Application Publication
(10) Pub. No.: US 2013/0271476 A1
(43) Pub. Date: Oct. 17, 2013

(54) Methods and Systems Related to Template Code Generator

(71) Applicant: Daniel L. TREIMAN, Round Rock, TX (US)

(72) Inventor: Daniel L. TREIMAN, Round Rock, TX (US)

(73) Assignee: GAMESALAD, INC., Austin, TX (US)

(21) Appl. No.: 13/448,983

(22) Filed: Apr. 17, 2012

(51) Int. Cl. G06T 1/00; G06F 9/45

(52) U.S. Cl. 345/522; 717/146

(57) ABSTRACT

Template Code Generator. At least some embodiments involve reading a first representation of a program in a first format, and creating a second representation of the program in a second format. The creating the second representation may involve reading a first portion of the first representation, determining a function of the first portion within the program, selecting a first code template from a plurality of code templates based on the function of the first portion, and placing the first code template into the second representation. An executable for a predetermined platform is created by compiling the second representation.

### CROSS-REFERENCE TO RELATED APPLICATIONS

None.

### BACKGROUND

Interactive multimedia applications, such as computer games, have become a major market component in the world economy. The electronic game markets comprise not only massive online multi-player games and console games, but also games for portable multi-function computing devices such as iPhone® and iPad® brand devices available from Apple, Inc. of Cupertino, Calif.

Interactive multimedia application creation is a highly creative art, and as such is attractive to those with creative personality types. On the other hand, computer programming has generally been the domain of logical, methodical personalities, who view the world as a discrete series of steps. While in some cases the highly creative personality will coincide with the highly logical personality, in most cases the abilities do not reside fully in a single individual. For that reason, many highly creative people find it difficult to write source code for programming of interactive multimedia applications.

Another issue that faces developers is varying platforms upon which multimedia applications may be executed. A significant amount of work on the part of the programmer may be required to create an executable version of an interactive multimedia application for different platforms (e.g., on processors that implement different instruction sets) even when appearance and interaction as between the platforms seems exactly the same.

Thus, any advance which makes the programming easier, and/or which makes creating executable versions of an application available for many different platforms easier, faster, and more efficient, would provide a competitive advantage in the marketplace.

### BRIEF DESCRIPTION OF THE DRAWINGS

For a detailed description of exemplary embodiments, reference will now be made to the accompanying drawings in which:

FIG. 1 shows a block diagram of components used in interactive game creation in accordance with at least some embodiments;

FIG. 2 shows a block diagram of creation of executable deliverables of interactive games in accordance with at least some embodiments;

FIG. 3 shows a tree structure that logically depicts game organization in accordance with at least some embodiments;

FIG. 4 shows a tree structure that logically depicts various aspects of actors in accordance with at least some embodiments;

FIG. 5 shows a tree structure that logically depicts a representation of a game in a portable game format in accordance with at least some embodiments;

FIG. 6 shows a block diagram depicting the illustrative journey of an executable from the input of the first representation through the output of the compiled executable, and in accordance with at least some embodiments;

FIG. 7 shows a block diagram representation of a code generator, in accordance with at least some embodiments;

FIG. 8 shows a block diagram representation of a runtime engine in accordance with at least some embodiments; and

FIG. 9 shows a computer system in accordance with at least some embodiments.

### NOTATION AND NOMENCLATURE

Certain terms are used throughout the following description and claims to refer to particular system components. As one skilled in the art will appreciate, different companies may refer to a component and/or method by different names. This document does not intend to distinguish between components and/or methods that differ in name but not function.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection or through an indirect connection via other devices and connections.

“Declarative programming language” shall mean a programming style that expresses logic of a computation without describing the order in which the individual statements of a program are executed or evaluated.

“Object-oriented programming language” shall mean a programming language that enables the programmer to associate a set of procedures with each type of data structure.

“Platform” shall mean a combination of hardware architecture and operating system software.

“Header file” shall mean a file that defines constants, variables, and functions, and which is included in other code files.

“Implementation file” shall mean a file used to contain the implementation code for the methods of a class.

“Constant folding” shall refer to the process of simplifying constant expressions at compile time.

“Remote” shall mean one kilometer or more.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

The various embodiments are directed to an interactive multimedia application development platform. More particularly, at least some embodiments are directed to a platform that enables “visual” (e.g., drag and drop) programming in a declarative programming style. At least some embodiments are directed to representing an interactive multimedia application in a format which is portable across many execution platforms. The various embodiments were developed in the context of the interactive multimedia applications being interactive multimedia computer games, and thus the specification is based on the developmental context; however, the developmental context shall not be read as a limitation as to the scope of the various embodiments. The specification first turns to a high level description of the various software components associated with application creation.

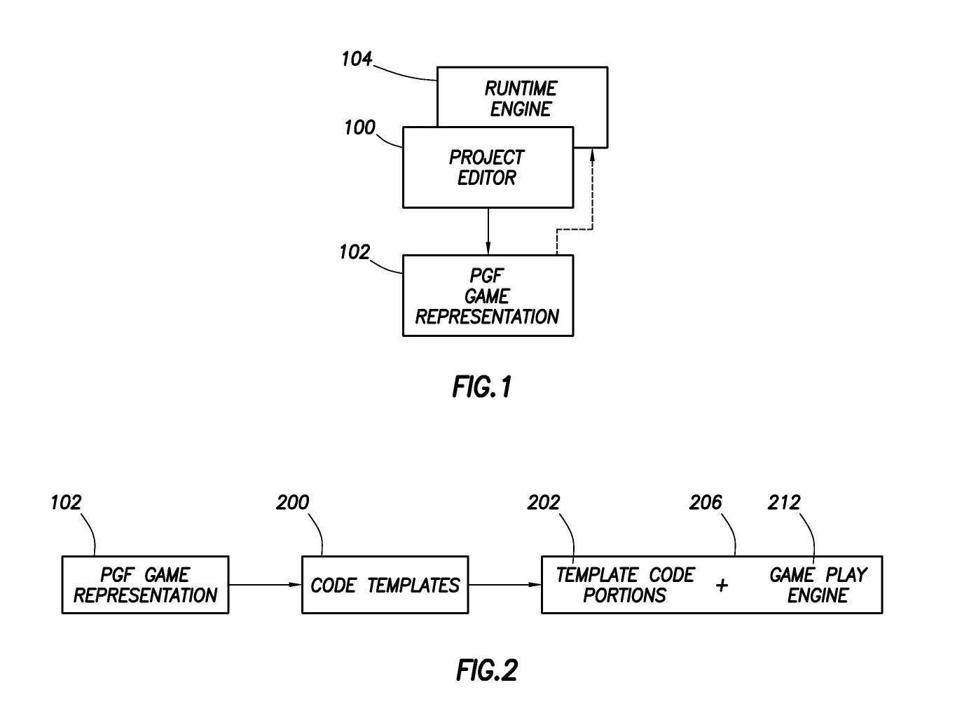

FIG. 1 shows, in block diagram form, a high level overview of the various components used in game creation in accordance with at least some embodiments. In particular, interactive games may be created and/or edited by way of a project editor 100. In a particular embodiment, the project editor 100 is a browser-based executable program, and in yet still other cases the project editor may be a standalone software package that executes on the computer system. In accordance with at least some embodiments, the project editor 100 enables creation and/or editing of a game visually, without the need to create source code.

The process of creating a game by interaction with the project editor 100 creates a representation of the game 102 in a format termed herein portable game format (PGF). A PGF game representation 102 is not source code, and is not compiled in the traditional sense; rather, the PGF game representation 102 defines the game flow or design in such a way that, in the creation environment, a runtime engine may interpret the information contained in the PGF game representation 102, and based on the interpretation the runtime engine could become the executable code of the game.

Still referring to FIG. 1, the project editor 100 is associated with a runtime engine 104. The runtime engine 104 reads the game 102 in the PGF game representation 102 and configures itself to execute or play out the game, including creation of the visual aspects and reading data from input devices. The project editor 100 is associated with the runtime engine 104 such that, at various times during the creation process, the user may run the game, or portions of the game, to evaluate game development and make decisions and/or changes in game play.

FIG. 1 illustrates the creation environment; however, in order to make the game available on different computer systems (i.e., different platforms), prior to the current disclosure the PGF game representation 102 was combined with a runtime engine configured for the target computer system. The runtime engine of the related-art has the ability to interpret any of a plurality of possible coded situations and/or functions that may reside in a PGF game representation 102, regardless of whether a specific game implements all of the situations represented by the PGF game representation 102. Thus, the runtime engine of the related art in many cases has a greater ability than needed to implement the game, making the runtime engine bulky and degrading performance.

In accordance with various embodiments described herein, however, for each specific platform on which the game is to be played, an executable file (or set of executable files) is created based on the PGF game representation 102. The executable file contains computer code used to implement the specific game play functions. However, situations and functions that are not implemented in the game need not be accounted for in the executable file, which makes the executable file less bulky and makes execution more efficient (compared to the related-art runtime engine that directly implements the game from the PGF game representation 102). The creation of the executable file may comprise reading the PGF game representation 102, and creating based on the PGF game representation 102 a second representation in a different programming language (e.g., imperative programming language, object oriented programming language). Once the second representation is completed, the second representation is compiled by a compiler to create an executable file for a predetermined platform.

FIG. 2 shows in block diagram form a logical representation of a portion of the creation of language-specific executable files in accordance with at least some embodiments. In particular, FIG. 2 illustrates a game 102 in the declarative PGF game representation 102 format, along with an illustrative set of language-specific code templates 200. Each set of code templates 200 is written in a specific language. For example, the code templates 200 may be written in C++(and may herein be referred to as “C++ code templates 200”); however, the set of code templates need not be C++, and other languages may be used (e.g., Javascript).

Based on the PGF game representation 102, selected template code portions 202 of the C++ code templates 200 are amassed along with a Game Play Engine 212 to produce one or more source code files 206 (hereafter just “source code” 206). Much like selected portions of the illustrative C++ code templates 200, the Game Play Engine 212 is not itself executable, but contains language-specific (for example, C++) files compiled into the game. For example, the illustrative Game Play Engine 212 may include a physics engine and geometry engine. The physics engine may comprise code which provides a simulation of physical systems such as rigid body dynamics, soft body dynamics, and fluid dynamics. The geometry engine may comprise code which renders geometric shapes, such as a cube or a sphere (e.g., game actors, discussed below). Additionally, platform-specific wrapper files, which are called by platform-specific code to enable non-specific language instructions to be interpreted within the context of the desired platform, may be included in the Game Play Engine 212. The source code 206, which comprises selected template code portions 202 of the code templates 200 combined with the Game Play Engine 212, is compiled by a compiler to create an executable file for a predetermined platform (e.g., Apple iOS for iPad or iPhone).

In order to give the reader a better understanding of how code templates 200 work with the PGF game representation 102 to create a portion of source code 206, the discussion turns briefly to a description of the PGF game representation 102 itself.

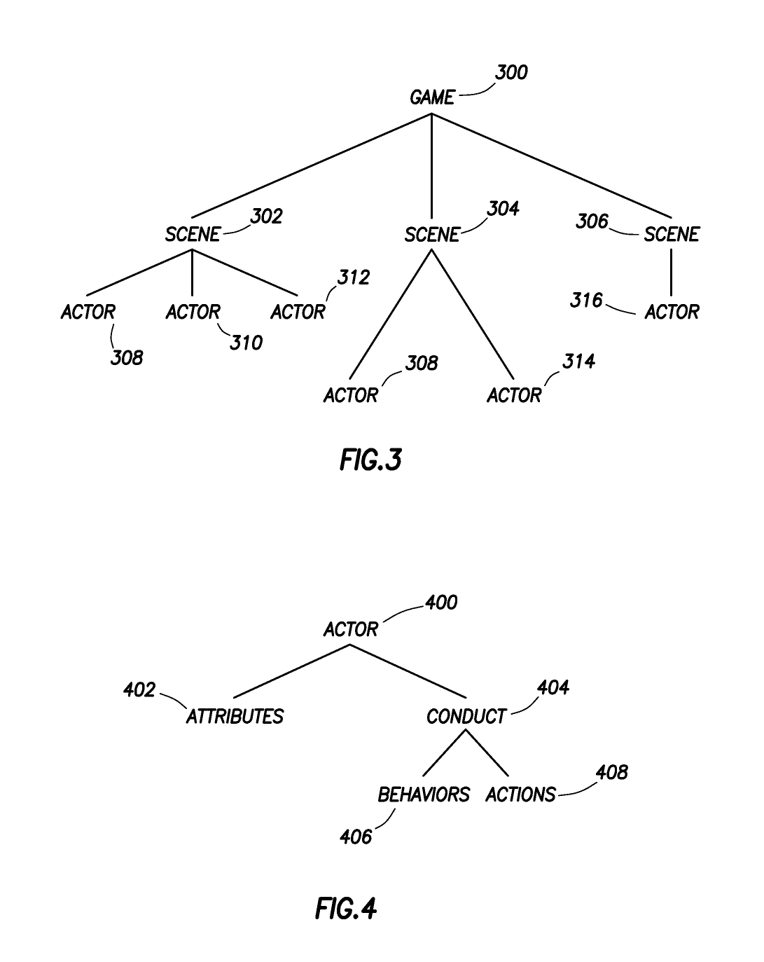

FIG. 3 illustrates a tree structure that logically depicts various aspects of game organization in accordance with at least some embodiments. In particular, FIG. 3 shows that a game 300 contains scenes. In the illustrative case of FIG. 3, game 300 contains three scenes 302, 304, and 306, but any number of scenes may be equivalently used, including “simple” games containing only one scene. Scenes may take place in any order. Within each scene are actors. For example, scene 302 illustratively contains three actors 308, 310, and 312. In a particular embodiment, every object in scene is an actor. For example, consider a classic paddle and ball game where two players each control the direction (along an axis) and acceleration of one of two paddles, which collide with a bouncing ball. Not only is the ball an actor, but also both paddles and the walls that define the game boundaries are actors.

Actors are not limited to particular scenes, and in fact an actor may span multiple scenes. In the example of FIG. 3, actor 308 spans both scene 302 and scene 304. Likewise, an actor may reside within a single scene, such as illustrative actor 314 residing only in scene 304, and actor 316 residing only in scene 306.

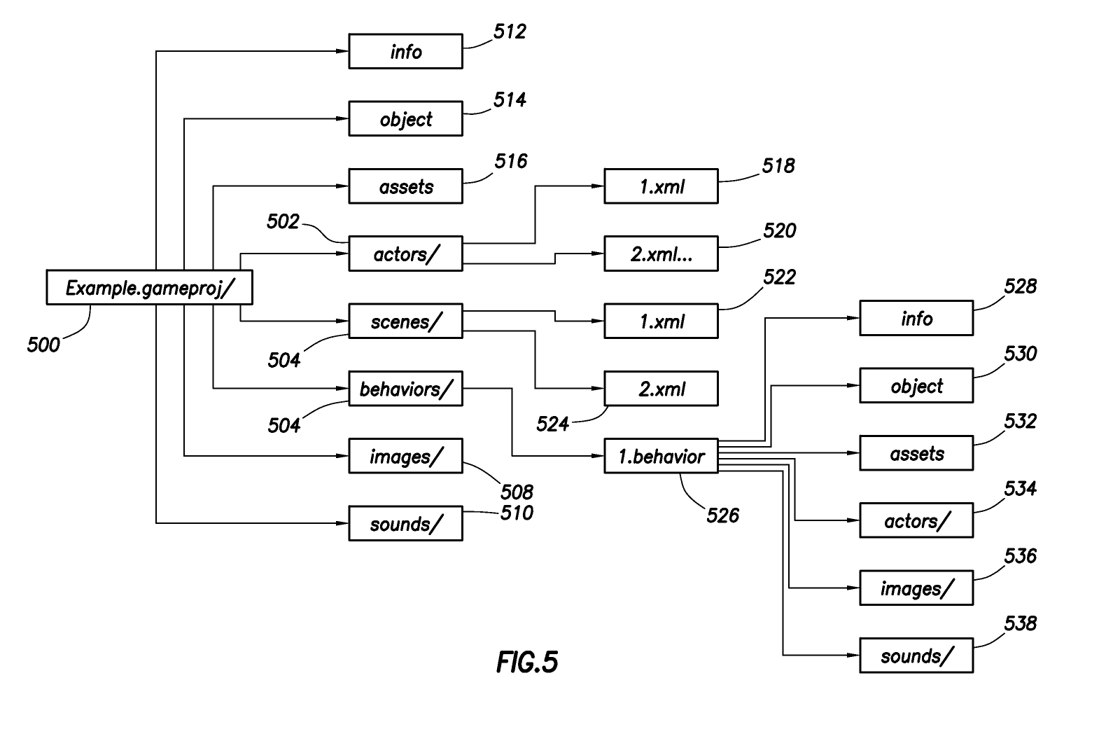

FIG. 4 illustrates a tree structure that logically depicts various aspects of an actor in accordance with at least some embodiments. In particular, FIG. 4 shows that an actor 400 is comprised of attributes 402 and conduct 404. Attributes 402 may define characteristics of the actor 400, such as initial position in the scene, size of the actor, color, rotational angle, the name of an image rendered on a screen that represents the actor, and visibility (some actors may be invisible). Moreover, attributes 402 may define data about how the actor 400 acts or reacts in a physics sense, such as whether the actor 400 is moveable, and if moveable the density of the actor 400 (e.g., density may control rate of acceleration), and friction of the actor 400 (e.g., may control how quickly the actor 400 decelerates in the absence of an applied force).

PGF Game Representation 102

In a particular embodiment, the PGF game representation 102 is a plurality of files that define aspects of the games, such as actors, scenes, and images rendered during the game. FIG. 5 shows an illustrative tree structure of a PGF game representation 102. In particular, FIG. 5 shows a block titled “Example.gameproj” 500. In some cases, the Example.gameproj 500 is a folder or directory of a file system within which the remaining files and directories are stored. In other cases, the Example.gameproj 500 is a theoretical construct used to form the base or root of the tree structure. The balance of the discussion will assume the Example.gameproj 500 is a folder. Within the folder 500 resides a plurality of other folders and files. In the example of FIG. 5, the folder 500 contains five additional folders, comprising the actors folder 502, the scenes folder 504, behaviors folder 506, images folder 508, and sounds folder 510. The illustrative folder 500 also contains files, comprising info file 512, object file 514, and assets file 516.

The info file 512 may contain information regarding the game represented in the PGF game representation 102, as well as information regarding the version of project editor 100 used to create the PGF game representation 102. In a particular embodiment, the info file 512 is coded in extensible markup language (XML); however, other coding schemes may be equivalently used, such as JavaScript Object Notation (JSON).

The assets file 516 may contain a manifest of information regarding assets of game, such as a list of sounds, images, behaviors, and actors. Inasmuch as the manifest of information in the assets file 516 may be gleaned by inspection of the other files and other folders, the assets file 516 may be omitted, or created at any time during and/or after game creation. In a particular embodiment, the assets file 516 is coded in XML; however, other coding schemes may be equivalently used.

Within the scenes folder 504 resides one or more files, such as the file 522 and 524 illustratively titled “1.xml” and “2.xml,” respectively. In a particular embodiment, each scene of the game has a respective file in the scenes folder 504. Thus, a first scene of the game may be represented by the scene file “1.xml”, a second scene of the game may be represented by the file titled “2.xml”, and so forth. However, in other embodiments the scenes may be contained in a single file. Each scene file contains a host of information about the scene. For example, the illustrative scene file 522 may contain information such as the name of the scene, window size for the scene, an indication of whether the scene wraps at the edges (e.g., whether an actor that moves out of the scene to the right re-appears on the left as if the space is connected along the vertical edges), an indication of the location to which acceleration due to gravity should be directed, initial color of the scene, initial camera location, initial window size for the camera, and (for portable devices) whether the scene should rotate as the device is rotated. In a particular embodiment, the information within scene file 522 is coded in XML; however, other coding schemes may be equivalently used.

The information regarding a scene may comprise more than just the set of initial information discussed in the previous paragraph. In some embodiments, a scene may have several “layers” within which actors may be placed. The layers do not necessarily imply depth, just a logical relationship for rendering the actors—in some cases actors at higher layers are rendered over actors at lower layers. For example, in the illustrative paddle game, the game designer may want to create what appears to be a tabletop in the scene for visual purposes. To implement such visual scene, the game designer may place a tabletop actor in one layer, and then the paddle actors and the ball actor in a “higher” layer such that the paddle actors and ball actor are rendered over the tabletop actor.

In addition to the information about the scene discussed above, each scene file may also contain information about the actor instances within the scene. Within the behaviors folder 506 may reside a file system element 526 illustratively titled “1.behavior.” In a particular embodiment, behaviors and/or actions may be grouped to form pre-packaged behavior sets or behavior bundles. The prepackaged behavior sets may then be quickly and easily applied to actors instantiated within a scene. In these embodiments, the behavior bundles may be stored within the PGF game representation 102 in the behaviors folder 506. In some cases, the illustrative “1.behavior” file system element 526 may be a file, coded in any suitable format, which defines the behavior bundle. In other cases, the illustrative “1.behavior” file system element 526 is a folder within which other files and folders may reside. For example, in the case where file system element 526 is a folder, the folder may contain files such as an information file 528, object file 530, and assets file 532. These files may perform a similar function to the info file 512, object file 514, and assets file 516 discussed above, but directed to the particular behavior bundle rather than the entire game. The files 528, 530, and 532 may be coded in any suitable form, such as XML. Moreover, where the file system element 526 is a folder, the actors folder 534, images folder 536, and sounds folder 538 may perform a similar function as the actors folder 502, images folder 508, and sounds folder 510 discussed above, but limited to the particular behavior bundle rather than the entire game. Now the discussion turns to the PGF Compiler.

PGF Compiler

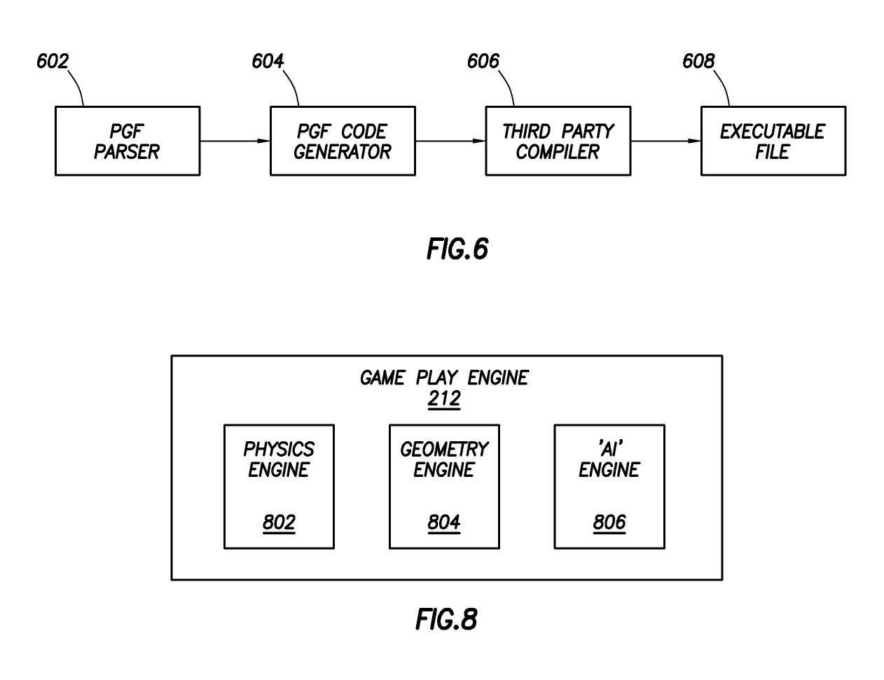

FIG. 6 shows, in block diagram form, illustrative logical components related to converting a game in PGF game representation 102 to an executable file for a specific platform. The PGF Compiler may comprise PGF Parser 602, PGF Code Generator 604, and Compiler 606, each of which will be described in turn.

PGF Parser

The PGF Parser 602 analyzes the PGF game representation 102 and creates one or more organizational tools. In particular, the PGF Parser 602 analyzes elements of the game (e.g., expression elements, function elements, actors and scene elements) and creates one or more organizational tools (e.g., object models, tree structures) that may assist in performing later steps. In other cases, the parser 602 may be omitted. The PGF Parser 602 provides the organization tools to the PGF Code Generator 604.

PGF Code Generator

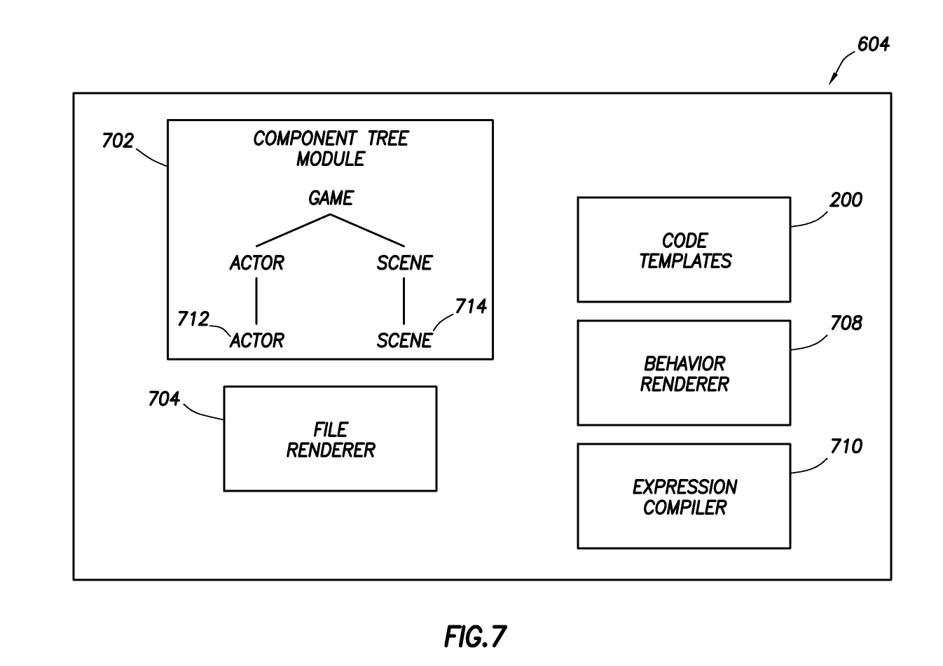

The PGF Code Generator 604 is the component responsible for identifying portions of the code templates 200 to be selected and placed into a portion of the source code 206. Various aspects of the PGF Code Generator 604 are shown in greater detail in FIG. 7. In particular, FIG. 7 shows, in block diagram form, that the PGF Code Generator 604 may comprise a Component Tree Module 702, a File Renderer Module 704, code templates 200, a Behavior Renderer Module 708 and a language-specific Expression Compiler 710.

The Component Tree Module 702 creates a component tree which contains the objects related to the PGF game representation 102, where each object may be a list of key value pairs that represent attributes. For example, a game has a set of actors 712 and scene 714 attributes, and each attribute has an entry in the component tree. The Component Tree Module 702 may read from the PGF game representation 102, and/or read from one or more of the organizational elements created by the PGF Parser 602, but the sources of data used to create the component tree are not necessarily limited to those two sources. The Component Tree Module 702 may make available the tree structure and/or the object information represented in the tree structure to be used by other components within the Code Generator 604. For example, the Component Tree Module 702 may make available the tree structure by the use of a recursive function, an iterator, and/or a pointer function, among other possibilities.

From the Component Tree Module 702, the objects are handed over to File Renderer 704. The File Renderer 704 performs the bulk of the work of identifying portions of code templates 200 which will make up a portion of the source code 206, with the Behavior Renderer 708 and Expression Compiler 710 addressing specific issues, as discussed more below. If the desired game file output language is C++, for example, the File Renderer 704 determines the functions represented by the PGF game representation 102, and then selects the code templates 200 for C++.

In order to show how portions of code templates 200 are identified and selected, reference is made to Table 1 below. In particular, Table 1 shows a portion of a PGF game representation 102 corresponding to an actor in a scene. The actor may be, for example, one of the player paddles in classic arcade paddle and ball game.

TABLE 1
<?xml version=”1.0” encoding=”UTF-8”?>
<scene id=”id269551” GSCVersion=”0.9.89” PFGVersion=”0.17”>

<layers>

<layer id= “id112326”>

<actors>
. . .

<actor id=“id180824” prototype=”id969353”>

<attributes>

<point id=”position”>

<real id=”x”>239.076</real>
<real id=”y”>307.969</real>

</point>
<size id= “size”>

<real id=”width”>479.566</real>
<real id=”height”>156.531</real>

</size>

</attributes>
<aspects/>

</actor>

</actors>
. . .

</layer>

```
  </layers>
  </attributes>
```

</scene>

Table 1 is illustrative of a scene with some number of layers, and in at least one layer resides actor with identifier “id180824” and with attributes “position” and “size.”

The File Renderer 704 may read the example portion in Table 1 of the PGF game representation 102 and may also read a portion of the document object model created by the PGF Parser 602. In this example, the File Renderer 704 determines the portion of the PGF game representation 102 to be an actor in a scene and selects the relevant portions of the code templates 200. For example, Table 2 shows a portion of code template 200 for a scene and a bolded portion thereof related to an actor within the scene. More specifically, the illustrative portions of code templates 200 that create an actor and set attributes of the actor to their initial states within a scene are selected.

TABLE 2
//
// {{namespace}}_{{scene_class}}.cpp
//
#include “{{namespace}}_{{scene_class}}.h”
#include “Layer.h”
{{#required_classes}}
#include “{{namespace}}_{{name}}.h”
{{/required_classes}}
using namespace gs;
// Default constructor implementation
{{namespace}}::{{scene_class}}::{{scene_class}}(gs::Game * game) :
Scene(game)
{{#attributes}}, {{name}}({{value}}){{/attributes}}
{
{{#attribute_initializations}}

{{name}} = {{value}};

{{/attribute_initializations}}
{{#layers}}

// Create layer
Layer * layer{{layer_index}} = new Layer(this, /* scrollable */
{{scrollable}});
{

{{#actors}}

/// Create actor
{{namespace}}::{{actor_{—}class}} * actor{{actor_{—}index}} = new

{{namespace}}::{{actor_{—}class}}(layer{{layer_{—}index}});

// set attributes of actor to their initial states

{{#attribute_{—}initializations}}

actor{{actor_{—}index}}−>{{name}} = {{value}};

{{/attribute_{—}initializations}}

// Add actor to layer
layer{{layer_index}}−>addActor(*actor{{actor_index}});

{{/actors}}

}
// Add layer to list of layers
layers.push_back(layer{{layer_index}});

{{/layers}}

/*
Required images:
{{#required_images}}
{{name}}
{{/required_images}}
Required sounds:
{{#required_sounds}}
{{name}}
{{/required_sounds}}
*/

}

Based on a determination by the File Renderer 704 that the function in question is an actor in a scene, portions of the code templates 200 related to an actor in a scene are carried through in creating portions of source code 206, as in Table 3 below.

TABLE 3
{
. . .

solitairepong::Actor2 * actor2 = new solitairepong::Actor2(layer0);
actor2−>position.x = 239.076;
actor2−>position.y = 307.969;
actor2−>size.width = 479.426;
actor2−>size.height = 24;
layer0−>addActor(*actor2);

. . .
}

Table 3 shows a portion of source code 206 in C++ which creates the actor in the scene, as well as the initialization of the actor attributes. That is, the illustrative game file “solitairepong” has an actor class “Actor2” in which “actor2” exists in “layer0.” While this example shows the creation of “actor2” in “layer0” (or the lowest layer), the scene itself may contain many layers and many actors. The initial position of “actor2” is initialized at the (x,y) coordinates of (239.076, 307.969), and of having width and height 479.426 and 24, respectively.

The specification now turns to a discussion of how variables from the PGF representation become variables in portions of the source code 206. Illustrative Table 4 below shows a portion of the PGF game representation 102 representing a scene in a game. The PGF game representation 102 includes the attributes of the scene itself, such as the size of the environment, as well as the actors and their attributes. For example, the bolded section of Table 4 shows the PGF game representation 102 of an actor with id number id180824, and the actor having an initial position and size.

TABLE 4
<?xml version=”1.0” encoding=”UTF-8”?>
<scene id=”id269551” GSCVersion=”0.9.89” PFGVersion=”0.17”>

<layers>

<layer id= “id112326”>

<actors>

<actor id=“id180824” prototype=”id969353”>

<attributes>

<point id=”position”>

<real id=”x”>239.076</real>
<real id=”y”>307.969</real>

</point>
<size id= “size”>

<real id=”width”>479.566</real>
<real id=”height”>156.531</real>

</size>

</attributes>
<aspects/>

</actor>
<actor id = “id971529” prototype=“id969353”>

<attributes>

<point id=“position”>

<real id=“x”>467.566</real>
<real id=“y”>156.531</real>

</point>
<size id =“size”>

<real id=“width”>24 </real>
<real id=“height”>289.734</real>

</size>

</attributes>
</aspects>

</actor>

</actors>
<attributes>

<text id=″name″>Background</text>
<boolean id=″scrollable″>true</boolean>

</attributes>

</layer>

</layers>
. . .

</scene>

The variables from the bolded portion of the PGF game representation 102 in Table 4 above may be in-lined into placeholders of code templates 200.

Table 5 represents a code template 200 specifically for a scene, and illustratively written in C++. The placeholders are represented between double curly brackets {{ }}. Double curly brackets containing a variable enable the substitution of a single variable. Double curly brackets containing a variable preceded by # and / enable the substitution of an array by marking the beginning and end of an array section, respectively. Placeholders within the array section (between {{#array_name}} and {{/array_name}}) will be rendered repeatedly, once for each element of the array. In these illustrative examples, an open source templating engine, such as the Mustache logic-less templating engine, may be used to aid with in-lining the PGF game representation 102 into the code templates 200. Although this example uses Mustache, any mechanism that aids in the substitution may be used. The placeholders will be replaced with the appropriate variables from the PGF game representation 102 shown above in Table 4. In this example, the bolded portion of Table 5 below represents the placeholders appropriate to hold the variables from the bolded portion of Table 4 above.

TABLE 5
//
// {{namespace}}_{{scene_class}}.cpp
//
#include “{{namespace}}_{{scene_class}}.h”
#include “Layer.h”
{{#required_classes}}
#include “{{namespace}}_{{name}}.h”
{{/required_classes}}
using namespace gs;
// Default constructor implementation
{{namespace}}::{{scene_class}}::{{scene_class}}(gs::Game * game) :
Scene(game)
{{#attributes}}, {{name}}({{value}}){{/attributes}}
{
{{#attribute_initializations}}

{{name}} = {{value}};

{{/attribute_initializations}}
{{#layers}}

// Create layer
Layer * layer{{layer_index}} = new Layer(this, /* scrollable */
{{scrollable}});
{

{{#actors}}

/// Create actor
{{namespace}}::{{actor_class}} * actor{{actor_index}} =
new

{{namespace}}::{{actor_class}}(layer{{layer_index}});

// set attributes of actor to their initial states

{{#attribute_{—}initializations}}

actor{{actor_{—}index}}−>{{name}} = {{value}};

{{/attribute_initializations}}

// Add actor to layer
layer{{layer_index}}−>addActor(*actor{{actor_index}});

{{/actors}}

}
// Add layer to list of layers
layers.push_back(layer{{layer_index}});

{{/layers}}

/*
Required images:
{{#required_images}}
{{name}}
{{/required_images}}
Required sounds:
{{#required_sounds}}
{{name}}
{{/required_sounds}}
*/

}

In particular, the bolded section in Table 5 represents the placeholders which initialize the variables of an actor. From Table 4, the reader can see that in the original PGF game representation 102, the value for the initial x position of “actor2” is set to 239.076, 307.969. In Table 5 above, placeholder “{{actor_index}}” will be replaced with the value “2” from Table 4 above; placeholder “{{name}}” will be replaced with the value “position.x” from Table 4 above; and placeholder “{{value}}” will be replaced with the value “239.076”.

Table 6 represents a portion of source code 206 related to the scene after the illustrative in-lining process.

TABLE 6

#include “solitairepong_Scene0.h”
#include “Layer.h”
#include “solitairepong_Actor0.h”
#include “solitairepong_Actor1.h”
#include “solitairepong_Actor2.h”
using namespace gs;
solitairepong::Scene0::Scene0(gs::Game * game) : Scene(game)
{

size.width = 480;
size.height = 320;
wrapX = false;
wrapY = false;
gravity.x = 0;
gravity.y = 0;
color.red = 0;
color.green = 0;
color.blue = 0;
color.alpha = 1;
camera.origin.x = 0;
camera.origin.y = 0;
camera.size.width = 480;
camera.size.height = 320;
camera.trackingArea.width = 400;
camera.trackingArea.height = 260;
camera.rotation = 0;
autorotate.landscapeLeft = true;
autorotate.landscapeRight = false;
autorotate.portrait = false;
autorotate.portraitUpsideDown = false;
name = “Initial Scene”;
time = 0;
Layer * layer0 = new Layer(this, /* scrollable */ true);
{

solitairepong::Actor0 * actor0 = new
solitairepong::Actor0(layer0);
actor0−>position.x = 71.3477;
actor0−>position.y = 164.762;
layer0−>addActor(*actor0);
solitairepong::Actor1 * actor1 = new
solitairepong::Actor1(layer0);
actor1−>position.x = 229.27;
actor1−>position.y= 158.496;
layer0−>addActor(*actor1);
solitairepong::Actor2 * actor2 = new
solitairepong::Actor2(layer0);
actor2−>position.x = 239.076;
actor2−>position.y = 307.969;
actor2−>size.width = 479.426;
actor2−>size.height = 24;
layer0−>addActor(*actor2);
solitairepong::Actor2 * actor3 = new
solitairepong::Actor2(layer0);
actor3−>position.x = 238.404;
actor3−>position.y = 9.49219;
actor3−>size.width = 479.426;
actor3−>size.height = 24;
layer0−>addActor(*actor3);
solitairepong::Actor2 * actor4 = new
solitairepong::Actor2(layer0);
actor4−>position.x = 467.566;
actor4−>position.y = 156.531;
actor4−>size.width = 24;
actor4−>size.height = 289.734;
layer0−>addActor(*actor4);

}
layers.push_back(layer0);
/*

Required images:
Required sounds:
*/

}

In particular, in Table 6 above placeholder “{{actor_index}}” has been replaced with the value “2” from Table 4 above; placeholder “{{name}}” has been replaced with the value “position.x” from Table 4 above; and placeholder “{{value}}” has been replaced with the value “239.076”. Although not specifically highlighted, Table 6 also shows how attributes related to the scene have carried through to the portion of source code 602 through in-lining. For example, the Initial Scene size of width 480 and height 320 has carried through from the PGF game representation 102 to the portion of source code 602 by the same illustrative process.

Behaviors

As discussed with respect to FIG. 4, actors in a game may have conduct comprising actions and behaviors (hereinafter referred to as “behavior”). Even a single behavior may have multiple modes in actual game play. When a behavior is activated, the result may be either “instantaneous” or “continuous.” Consider, for example, the continuous ConstrainAttribute behavior. The ConstrainAttribute behavior enables constraint of the attributes of an actor to a particular value and continuously updates the attributes (e.g., to constrain an actor's X, Y position). In the illustrative paddle and ball arcade game, the ConstrainAttribute behavior may keep the paddles contained within the boundaries of the playing field, as opposed to disappearing off the edges.

Alternatively, a behavior may be “instantaneous.” Consider, for example, the instantaneous ChangeVelocity behavior. The ChangeVelocity behavior enables movement of an actor at a particular velocity relative to the actor or to the scene. In the example of the paddle game, the ChangeVelocity behavior may be assigned to either or both of the paddles, and when the ChangeVelocity behavior is activated, the paddle actor may move at a particular velocity in a particular direction (e.g., movement to make contact with the ball).

If an actor contains at least one behavior, the behavior is rendered by the Behavior Renderer 708. The Behavior Renderer 708 may read a portion of the PGF game representation 102 and may also read a portion of the document object model created by the PGF Parser 602 related to the behavior. The Behavior Renderer 708 renders each behavior into a behavior code snippet. The behavior code snippet, alone or in combination with other behavior code snippets, is combined with a portion of code template 200 relating to the actor containing the behavior and is rendered by the File Renderer 704 to create a portion of source code 206. In some embodiments, each behavior code snippet rendered by the Behavior Renderer 708 is held in memory until it is called by the File Renderer 704.

In some embodiments, behaviors may be first rendered into behavior code snippets by the Behavior Renderer 708 such that they are subsequently available for the File Renderer 704 to combine with portions of code templates 200. In other embodiments, the File Renderer 704 may render code from the PGF game representation 102 and/or document object model first, and then the Behavior Renderer 708 may render the relevant behavior code snippets to be combined with portions of code templates 200. In yet still other embodiments, the Behavior Renderer 708 and the File Renderer 708 may work simultaneously to create and combine behavior code snippets and portions of code templates 200 rendered to create a portion of source code 206.

In accordance with at least some embodiments, to create the behavior code snippets behavior related data from the PGF game representation 102 is in-lined by the Behavior Renderer 708 into at least one of four behavior code templates specific to each behavior, although a different number of behavior code templates may be employed. For each behavior in the game, behavior code templates may include: a start code template; a stop code template; a declarations code template; and a initializations code template. For purposes of illustration, the ConstrainAttribute behavior is discussed in more detail.

The ConstrainAttribute behavior has a start code template which activates the ConstrainAttribute behavior. The start code template for the ConstrainAttribute behavior is illustratively shown below in Table 7.

TABLE 7

constrainAttributeBehavior{{behavior_id}}.start( );

The start code template above may be used to create a behavior code snippet which will start the Constrain Attribute behavior. In particular, the placeholder {{behavior_id}} is replaced with the behavior identifier which uniquely identifies the behavior within the context of the actor, and the completed template is rendered by the Behavior Renderer 708 to create a behavior code snippet.

The illustrative ConstrainAttribute behavior also has a stop code template which stops the ConstrainAttribute behavior. The ConstrainAttribute stop code template is illustratively shown below in Table 8.

TABLE 8

constrainAttributeBehavior{{behavior_id}}.stop( );

The stop code template above may be used to create a behavior code snippet which will stop the ConstrainAttribute behavior. In particular, the placeholder {{behavior_id}} is replaced with a behavior identifier which uniquely identifies the behavior within the context of the actor, and the completed template is rendered by the Behavior Renderer 708 to create a behavior code snippet.

The illustrative ConstrainAttribute behavior also has a declarations code template which describes declarations that may be inserted into the header file of the actor that contains the ConstrainAttribute behavior. A ConstrainAttribute declarations code template is illustratively shown below in Table 9.

TABLE 9
gs::ConstrainAttributeBehavior<{{#target_keypath}}{{value_type}}{{/target_keypath}},
{{reference_class}}, {{expression_class_RHS}}>
constrainAttributeBehavior{{behavior_id}};

The declarations code template may be used to create a behavior code snippet which will aid in declarations related to the ConstrainAttribute behavior. In particular, the placeholders {{#target_keypath}}, {{value_type}}, {{/target_keypath}}, {{reference_class}}, {{expression_class_RHS}} and {{behavior_id}} will be replaced with the variables which correspond to the actor whose attribute will be constrained, and the completed template is rendered by the Behavior Renderer 708 to create a behavior code snippet.

The illustrative ConstrainAttribute behavior also has an initializations code template which initializes objects declared by the declarations and is used in conjunction with the declarations code template from Table 9 above. The ConstrainAttribute initializations code template is illustratively shown below in Table 10.

TABLE 10

constrainAttributeBehavior{{behavior_id}}(this)

The initializations code template may be used to create a behavior code snippet which will initialize objects declared by the declarations behavior code snippet. In particular, the placeholder {{behavior_id}} is replaced with the behavior identifier which uniquely identifies the behavior within the context of the actor, and the completed template is rendered by the Behavior Renderer 708 to create another behavior code snippet.

In contrast, instantaneous behaviors (or actions) may use one template, such as a start template, to start the action or activate the behavior. An illustrative start template for the CollideBehavior is shown in Table 11 below.

TABLE 11
// CollideBehavior{{behavior_id}}
// Collide with collision category index: {{target_collision_category}}
getActor( )−>enableBounceAgainst({{target_collision_category}};
// CollideBehavior{{behavior_id}}

CollideBehavior is an instantaneous behavior which enables actors to collide with one another in elastic-style collisions. If CollideBehavior is enabled for an actor, or a group of actors, the illustrative start template in Table 11 above is rendered by the Behavior Renderer 708 to create a CollideBehavior behavior code snippet. The CollideBehavior behavior code snippet is combined with a portion of code template 200 related to the actor containing the CollideBehavior and is then rendered by the File Renderer 704 to create a portion of source code 206.

In order to show how the File Renderer 704 combines behavior code snippets created by the Behavior Renderer 708 to render a portion of source code 206, reference is made to Tables 12-14 below. In this illustrative example, behavior code templates related to the ConstrainAttribute behavior are rendered by the Behavior Renderer 708 to create behavior code snippets. In particular, the Behavior Renderer 708 reads a portion of the PGF representation or the document object model and determines whether there is a behavior. If there is a behavior, the Behavior Renderer 708 in-lines variables into placeholders within the behavior code templates, and renders behavior code snippets. In particular, Table 12 is illustrative of a start template for the ConstrainAttribute behavior.

TABLE 12

constrainAttributeBehavior{{behavior_id}}.start( );

The start template for the ConstrainAttribute behavior in Table 12 may be compared to the behavior code snippet found in Table 7. In this example, the Behavior Renderer in-lines the behavior identifier which uniquely identifies the behavior within the context of the actor into the placeholder {{behavior_id}} found in the start code template in Table 12.

An example behavior code snippet created by the Behavior Renderer from the template shown in Table 12 is shown below in Table 13.

TABLE 13

constrainAttributeBehavior0.start( );

In particular, the behavior code snippet in Table 13 is illustratively rendered by the Behavior Renderer 708 from the start code template of Table 12 by in-lining the behavior identifier “0” into the placeholder {{behavior_id}}.

Table 14 is illustrative of a portion of code template 200 related to an actor containing a behavior. This illustrative example shows a start method which may be called to start the behavior when the related actor becomes active in a scene.

TABLE 14

void {{namespace}}::{{actor_class}}::start(const Timestamp
&timestamp)
{

Actor::start(timestamp);

{{#behaviors}}
{{{startCode}}}
{{/behaviors}}
}

In particular, the bolded section of Table 14 above is a placeholder in a portion of code template 200 in which related behavior code snippets may be in-lined by the File Renderer 704.

Table 15 below shows a portion of source code 206 after having been rendered by both the Behavior Renderer 708 and the File Renderer 704.

TABLE 15

void solitairepong::Actor0::start(const Timestamp &timestamp)
{

Actor::start(timestamp);
constrainAttributeBehavior0.start( );
constrainAttributeBehavior1.start( );

}

Specifically, the behavior code snippet from Table 13 has been combined with a portion of code template 200 for the actor containing the ConstrainAttribute behavior (shown in Table 15), and has been rendered by the File Renderer 704 to create a portion of source code 206.

If the behavior is directly contained by an actor (e.g., constraining an attribute), the File Renderer 704 in-lines behavior code snippets created by the Behavior Renderer 708 into the code template 200 for the actor containing the behavior. If the behavior is contained within another behavior (i.e. a Rule or Timer behavior), the File Renderer 704 renders the behavior code snippets directly into the code of the containing behavior (Rule or Timer). In this manner behavior code may be nested.

The specification now turns to expressions.

Expression Compiler

A behavior may contain one or more expressions which may be combined with behavior code templates or other code templates to create a portion of source code 206. Expressions, however, may go through syntax checking and other transformations before being combined with behavior code templates or other code templates 200.

In preparing expressions to be compiled, an Expression Compiler 710 renders expressions represented by a PGF game representation 102 into a portion of source code 206. A parser within the Expression Compiler 710 reads the expression character by character to determine the types of objects represented (e.g., a number, a function call, a string), and returns an expression tree of objects. The parser simplifies the expression by collapsing nodes into fewer objects. Simplification may also be done by constant folding when the parser performs arithmetic at parse time, rather than at compile time.

From the simplified tree, the Expression Compiler 710 resolves the types of the objects. For example, a dynamically-typed language such as Python may be flexible as to the type of input accepted, whereas a strongly-typed language such as C++ may not accept input data if they are of an unexpected type (e.g. in C++ the cosine function expects a floating point value and may not accept an integer). The Expression Compiler 710, therefore, traverses the expression tree of objects and uses rules to deduce the type of each object. If there is a case where a type may not be converted, a type conversion operation may detect the expected input and output types and make conversions.

As the Expression Compiler 710 traverses the expression tree, the Expression Compiler 710 translates the nodes of the expression tree of objects into code strings. If the desired language is C++, for example, the Expression Compiler translates the expression tree of objects into a code string of C++. The code string is combined with a portion of an expression code template, and the Expression Compiler 710 renders each expression as a class, with a header and implementation file, and uses a table of inputs related to the expression to render a portion of source code 206 related to expressions

In order to show how the Expression Compiler 710 creates a portion of source code 206 related to expressions, reference is made to Tables 16-18 below. In this illustrative example, the function “cos(self.angle+90)*−100” is converted into C++ code string and combined with an expression.cpp template to create a portion of source code 206.

TABLE 16

(gs::expression::cos (self−>angle + (float)90) * (float) − 100)

In particular, Table 16 shows a C++ code string after the Expression Compiler 710 has traversed the expression tree and translated each node of the illustrative function.

Table 17 is illustrative of an expression code template for C++.

TABLE 17
{{value_type}} {{namespace}}::{{expression_class}}::evaluateForActor(gs::Actor *
actor)
{
{{#deterministic}}

setNeedsUpdate(false);

{{/deterministic}}
{{#references_actor}}

{{namespace}}::{{actor_class}} * self =
dynamic_cast<{{namespace}}::{{actor_class}} *>(actor);

{{/references_actor}}
{{#references_scene}}

{{namespace}}::{{scene_class}} * scene =
dynamic_cast<{{namespace}}::{{scene_class}} *>(actor−>getScene( ));

{{/references_scene}}
{{#references_game}}

{{namespace}}::{{game_class}} * game =
dynamic_cast<{{namespace}}::{{game_class}} *>(actor−>getGame( ));

{{/references_game}}
{{#referenced_actor_instances}}

{{actor_instance_class}} * instance{{actor_instance_identifier}} =
dynamic_cast<{{actor_instance_class}}

*>(actor−>getScene( )−>actorInstanceForIdentifier({{actor_instance_identifier}}));

if (!instance{{actor_instance_identifier}}) return NULL; // Check if instance
exists.

{{/referenced_actor_instances}}
return {{{expression_code}}};
}

In particular, code strings and inputs from a table of inputs related to expressions are in-lined into the expression code template.

Table 18 is illustrative of a rendered portion of source code 206 related to expressions.

TABLE 18

float ExampleExpression::evaluateForActor(Actor * actor)
{
Actor * self = actor;
return (gs::expressions::cos(self−>angle +(float)90)* (float)−100);
}
void ExampleExpression::observeInputs(Actor * actor)
{
Actor * self = actor;
self−>angle.addObserver(this,
&ExampleExpression::self_angle_attributeChanged);
}
void ExampleExpression::releaseInputs(Actor * actor)
{
Actor * self = actor;self−>angle.removeObserver(this,
&ExampleExpression:: self_angle_attributeChanged);
}
void self_angle_attributeChanged(float oldValue,float newValue)
{
observeValueChanges( )
}

In particular, the bolded portion in the table above shows the expression code string generated in Table 16 as combined with a portion of expression code template to produce a portion of source code 260.

Game Play Engine

The specification now turns to a more detailed description of the Game Play Engine 212. The Game Play Engine 212 may be a collection of software libraries which provide a defined application programming interface (“API”) to create application or game specific source code. FIG. 8 shows in block diagram form possible components of the Game Play Engine 212. In particular, the Game Play Engine 212 may be considered as software to provide functionality for games, the software of which may change based on source code from the specific game.

The functionality of the Game Play Engine 212 may include components such as a physics engine 802, a geometry engine 804, and an artificial intelligence engine 806. In particular, the physics engine 802 may be software which provides simulation of physical systems in games and applications, such as rigid body dynamics, collision detection, soft body dynamics, and fluid dynamics. The geometry engine 804 may be software which performs image generation based on geometric models, such as the generation of a rectangle for a paddle or a sphere for a ball. The artificial intelligence engine 806 may be a set of algorithms that alters the behavior of non-player actors to give them artificial intelligence.

While a sample of functionalities is discussed above, the Game Play Engine 212 may also contain software libraries which affect sound, memory management, animation, and other such functionalities which may affect the source code at compilation time regardless of the specifically programmed application or game.

Example Computing Environment

The various embodiments discussed to this point operate on computer systems of varying forms. For example, the project editor 100 and runtime engine 104 may execute on a desktop or laptop computer system. The source code 206, after compiling, may execute on any appropriate hardware, such as an iPhone® or iPad® brand product.

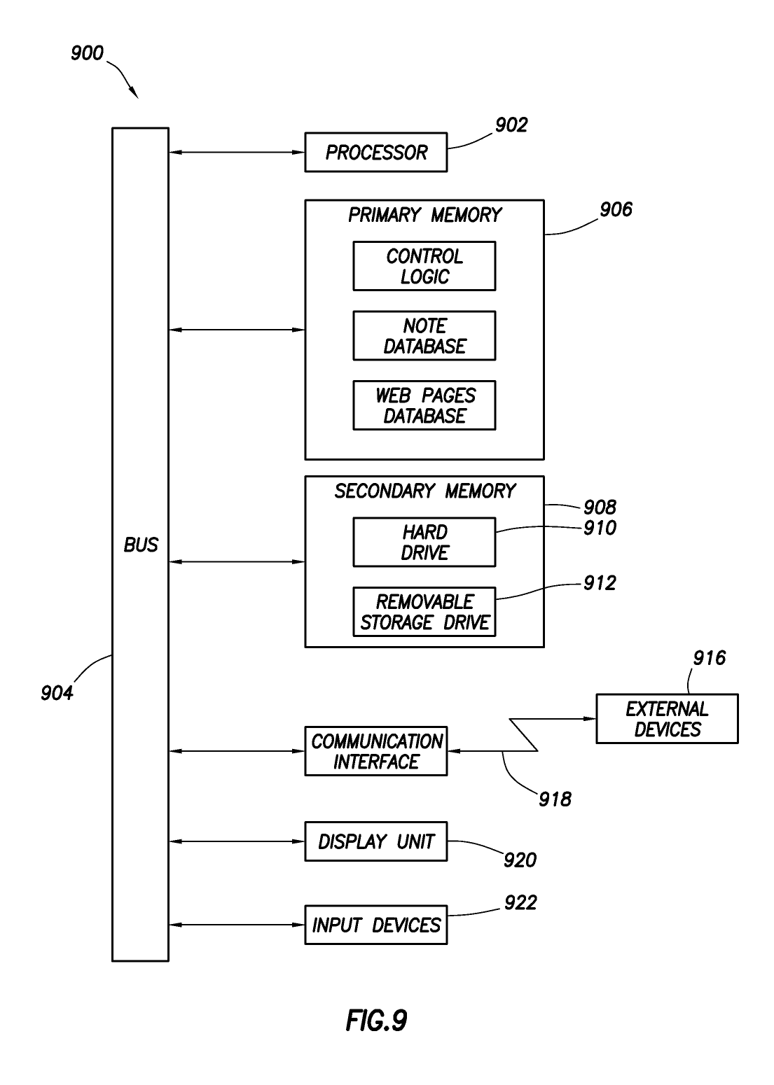

FIG. 9 shows an illustrative computer system 900 in accordance with at least some embodiments. The illustrative computer system 900 could be the environment on which the project editor 100 and runtime engine 104 are executed. Additionally, the illustrative computer system 900 could be the environment on which the PGF game representation is created, on which template code portions are created, on which source code 206 may be created, or on which source code 206 is compiled. The computer system 900 comprises one or more processors, such as a processor 902. The processor 902 is coupled to a communication bus 904. The computer system 900 also comprises a main or primary memory 906. The computer system 900 may also comprise a secondary memory 908. The secondary memory 908 may, for example, a hard disk drive 910 and/or a removable storage drive 912. Both the primary memory 906 and the secondary memory 908 are examples of computer-readable mediums upon which programs (executable by the processor 902) may be stored. Moreover, the primary memory 906 and the secondary memory 908 are examples of computer readable mediums upon which PGF game representation 102 may be stored.

The illustrative computer system 900 may also comprise communication interface 914. The communications interface 914 enables the computer system 900 to communicate and interact with locally or remotely located external devices 916 via a communications medium 918. In particular, communications interface 914 enables the computer system 900 to send and receive software and data to/from the external devices 916. Examples of the communications interface 914 comprise a modem, a network interface (such as a wired or wireless Ethernet card or a cellular card), a communications port, etc. The illustrative computer system 900 may also comprise a display unit 920, such as a computer monitor, and one or more input devices 922, such as a keyboard and a pointing device (such as a mouse, trackball, etc.). One skilled in the art will readily recognized that the components described herein are employed in numerous computing devices, including, without limitation, personal computers, cell phones, portable music players that incorporate display, and tablet computers.

From the description provided herein, those skilled in the art are readily able to combine software created as described with appropriate general-purpose or special-purpose computer hardware to create a computer system and/or computer sub-components in accordance with the various embodiments, to create a computer system and/or computer sub-components for carrying out the methods of the various embodiments, and/or to create a non-transitory computer-readable storage medium (i.e., other than an signal traveling along a conductor or carrier wave) for storing a software program to implement the method aspects of the various embodiments.

The above discussion is meant to be illustrative of the principles and various embodiments of the present invention. Numerous variations and modifications will become apparent to those skilled in the art once the above disclosure is fully appreciated. For example, while the various software components have been described in terms of game creation, the development context shall not be read as a limitation as to the scope of the one or more inventions described—the same techniques may be equivalently used for non-game programming. That is, the programming interfaces, portable format, execution engine, and code generator operation are equally applicable to any interactive multimedia application development, such as interactive books, interactive novels, educational tools, and animation. It is intended that the following claims be interpreted to embrace all such variations and modifications.

What is claimed is:

1. A method comprising:
reading a first representation of a program, the first representation in a first format;
creating a second representation of the program, the second representation in a second format, the creating by:
reading a first portion of the first representation;
determining a function of the first portion within the program;
selecting a first code template from a plurality of code templates, the selecting based on the function of the first portion;
placing the first code template into the second representation; and then
compiling the second representation to create an executable code for a predetermined platform.

2. The method of claim 1 wherein the plurality of code templates comprises the first code template for a first function and a second code template for a second function, and wherein the method further comprises refraining from inserting the second code template in the absence of the second function within the first representation.

3. The method of claim 1 further comprising:
wherein the first code template comprises a placeholder;
wherein the first portion comprises a variable; and
inserting the variable of the first portion into the placeholder before compiling the second representation.

4. The method of claim 3 wherein inserting further comprises inserting the variable into the first code template, the inserting the variable prior to placing the first code template.

5. The method of claim 3 wherein inserting further comprises inserting the variable of the first portion after placing the first code template.

6. The method of claim 1:
wherein determining the function further comprises determining the first portion represents a persistent behavior; and
wherein selecting further comprises selecting the first code template that implements the persistent behavior.

7. The method of claim 6 wherein selecting further comprises selecting at least one from the group consisting of: a code template comprising instructions that, when compiled and executed, starts the persistent behavior; and a code template comprising instructions that, when compiled and executed, stops the persistent behavior.

8. The method of claim 1 wherein selecting further comprises selecting the first code template comprising instructions that, when complied and executed, renders a scene.

9. The method of claim 1 wherein selecting further comprises selecting the first code template comprising instructions that, when complied and executed, renders an actor in a scene.

10. The method of claim 1 wherein selecting further comprises selecting the first code template comprising instructions that, when complied and executed, removes an actor from the scene.

11. The method of claim 1 wherein selecting further comprises selecting the first code template comprising instructions that, when complied and executed, moves an actor in a scene.

12. The method of claim 1:
wherein determining further comprises determining the first portion is a behavior; and
wherein placing further comprises placing the first code template into at least one selected from the group consisting of: a header file related to the behavior; and an implementation file related to the behavior.

13. The method of claim 13 wherein the behavior is one selected from the group consisting of: a rule behavior; and a timer behavior.

14. The method of claim 1 wherein the second representation represents at least one from the group of: actor; scene; and behavior.

15. The method of claim 1 wherein the first format is a declarative programming language.

16. The method of claim 1 wherein the second format is at least one selected from the group consisting of: an object oriented programming language; and an imperative programming language.

17. A non-transitory computer-readable medium storing instructions that, when executed by a processor, causes the processor to:
read a first representation of a program, the first representation in a first format;
create a second representation of the program, and when the processor creates the second representation of the program, the instructions cause the processor to:
read a first portion of the first representation;
determine a function of the first portion within the program;
select a first code template from a plurality of code templates, the selecting based on the function of the first portion; and
place the first code template into the second representation; and then
compile the second representation to create an executable code for a predetermined platform.

18. The non-transitory computer-readable medium of claim 17 wherein the instructions further cause the processor to send the executable code to a remote computer system.

19. The non-transitory computer-readable medium of claim 17 wherein the plurality of code templates is comprised of the first code template for a first function and a second code template for a second function, and wherein the instructions further cause the processor to refrain from inserting the second code template in the absence of the second function within the first representation.

20. The non-transitory computer-readable medium of claim 17:
wherein the first code template comprises a placeholder;
wherein the first portion comprises a variable; and
wherein the instructions further cause the processor to insert the variable of the first portion into the placeholder before compiling the second representation.

21. The non-transitory computer-readable medium of claim 20 wherein when the processor inserts, the instructions cause the processor to insert the variable prior to placing the first code template.

22. The non-transitory computer-readable medium of claim 20 wherein when the processor inserts, the instructions cause the processor to insert the variable of the first portion after placing the first code template.

23. The non-transitory computer-readable medium of claim 17:
wherein when the processor determines, the instructions further cause the processor to determine that the first portion represents a persistent behavior; and
wherein when the processor selects, the instructions further cause the processor to select the first code template that implements the persistent behavior.

24. The non-transitory computer-readable medium of claim 23 wherein when the processor selects, the instructions further cause the processor to select at least one from the group consisting of: a code template comprising instructions that cause the processor to start the persistent behavior; and a code template comprising instructions that cause the processor to stop the persistent behavior.

25. The non-transitory computer-readable medium of claim 17 wherein when the processor selects, the instructions further cause the processor to select the first code template with instructions that, when compiled and executed, renders a scene.

26. The non-transitory computer-readable medium of claim 17 wherein when the processor selects, the instructions further cause the processor to select the first code template with instructions that, when compiled and executed, renders an actor in a scene.

27. The non-transitory computer-readable medium of claim 17 wherein when the processor selects, the instructions cause the processor to select the first code template comprising instructions that, when compiled and executed, removes an actor in a scene.

28. The non-transitory computer-readable medium of claim 17 wherein when the processor selects, the instructions cause the processor to select the first code template comprising instructions that, when compiled and executed, moves an actor in a scene.

29. The non-transitory computer-readable medium of claim 17:
wherein when the processor determines, the instructions further case the processor to determine the first portion is a behavior; and
wherein when the processor places, the instruction cause the processor to place the first code template into at least one selected from the group consisting of: a header file related to the behavior; and an implementation file related to the behavior.

30. The system of claim 29, wherein the behavior is at least one selected from the group consisting of: a timer behavior; and a rule behavior.

31. A computer system comprising:
a processor;
a memory coupled to the processor;
wherein the memory stores instructions that, when executed by the processor, causes the processor to:
read a first representation of a program, the first representation in a first format;
create a second representation of the program, and when the processor creates the second representation of the program, the instructions cause the processor to:
read a first portion of the first representation;
determine a function of the first portion within the program;
select a first code template from a plurality of code templates, the selecting based on the function of the first portion;
place the first code template into the second representation; and then
compile the second representation to create an executable code for a predetermined platform.

32. The computer system of claim 31 wherein the instructions further cause the processor to send the executable code to a remote computer system.

33. The computer system of claim 31:
wherein when the processor determines, the instructions further cause the processor to determine that the first portion represents a persistent behavior; and
wherein when the processor selects, the instructions further cause the processor to select the first code template that implements the persistent behavior.

34. The computer system of claim 33 wherein when the processor selects, the instructions further cause the processor to select at least one from the group consisting of: a code template comprising instructions that cause the processor to start the persistent behavior; and a code template comprising instructions that cause the processor to stop the persistent behavior.

35. The computer system of claim 33 wherein when the processor selects, the instructions further cause the processor to select the first code template with instructions that, when compiled and executed, renders a scene.

36. The computer system of claim 33 wherein when the processor selects, the instructions further cause the processor to select the first code template with instructions that, when compiled and executed, renders an actor in a scene.

37. The computer system of claim 33 wherein when the processor selects, the instructions cause the processor to select the first code template comprising instructions that, when compiled and executed, removes an actor in a scene.

38. The computer system of claim 33 wherein when the processor selects, the instructions cause the processor to select the first code template comprising instructions that, when compiled and executed, moves an actor in a scene.

39. The computer system of claim 33:
wherein when the processor determines, the instructions further cause the processor to determine the first portion is a behavior; and
wherein when the processor places, the instructions cause the processor to place the first code template into at least one selected from the group consisting of: a header file related to the behavior; and an implementation file related to the behavior.

40. The system of claim 39, wherein the behavior is at least one selected from the group consisting of: a timer behavior; and a rule behavior.
